(19) United States
(12) Patent Application Publication
(10) Pub. No.: US 2010/0237997 A1
(43) Pub. Date: Sep. 23, 2010

(54) HANDY READER

(75) Inventor: Yoshinori Asai, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/716,821

(22) Filed: Mar. 3, 2010

(30) Foreign Application Priority Data
Mar. 19, 2009 (JP) 2009-068330

(51) Int. Cl. H04Q 5/22

(52) U.S. Cl. 340/10.1

(57) ABSTRACT

A handy reader includes: an antenna unit configured to perform radio communication with a radio tag having data stored therein to thereby read the data stored in the radio tag; a fixing member configured to detachably fix a portable terminal mounted with a display unit configured to display the data read from the radio tag by the antenna unit; and a communication unit configured to perform radio communication with the portable terminal to thereby transmit and receive the data.

### CROSS-REFERENCE TO RELATED APPLICATION

This application claims the benefit of priority from Japanese Patent Application No. 2009-68330 filed on Mar. 19, 2009, the entire content of which is incorporated herein by reference.

### TECHNICAL FIELD

The present invention relates to a handy reader.

### BACKGROUND

A handy reader is widespread which exchanges information with radio tags such as RFID (Radio Frequency Identification) tags attached to books and the like stored in stacks of a library and the like through short distance radio communication using an electromagnetic field, a radio wave, and the like.

For example, JP-T-2006-502471 (the term “JP-T” as used herein means a published Japanese translation of a PCT patent application) discloses a hand-held user input and output unit configured to exchange information with radio tags through radio communication. The hand-held user input and output unit includes a docking connector to which a PDA (Personal Digital Assistant) apparatus is connected and a docking port like a hollow in which PDA apparatuses having various widths can be housed.

However, in operation, the hand-held user input and output unit disclosed in JP-T-2006-502471 can be coupled to a PDA apparatus available in the market. However, since the hand-held user input and output unit and the PDA apparatus are integrally used, when a user exchanges information with a radio tag located in a position away from the user, the user has to move the hand-held user input and output unit and the PDA apparatus to a position away from the user. Therefore, the user cannot see, by the user's side, a result of the exchange of the information with the radio tag by radio communication.

The present invention has been devised in view of the above and it is an object of the present invention to provide a handy reader with which, even when a user exchanges information with a radio tag located in a position away from the user, the user can easily see, by the user's side, a reading result of the information from the radio tag.

### SUMMARY

According to an aspect of the present invention, there is provided a handy reader including: an antenna unit configured to perform radio communication with a radio tag having data stored therein to thereby read the data stored in the radio tag; a fixing member configured to detachably fix a portable terminal mounted with a display unit configured to display the data read from the radio tag by the antenna unit; and a communication unit configured to perform radio communication with the portable terminal to thereby transmit and receive the data.

### DESCRIPTION OF THE DRAWINGS

FIG. 1 is a perspective view of an external form of an RFID tag reader viewed from a side thereof;

FIG. 2 is a perspective view of an external form of the RFID tag reader, from which a PDA is detached, viewed from the side;

FIG. 3 is a perspective view of an external form of the RFID tag reader viewed from another side thereof;

FIG. 4 is a longitudinal sectional view of the RFID tag reader;

FIG. 5 is a diagram for explaining a method of fixing the PDA to the RFID tag reader;

FIG. 6 is a diagram of external forms of the PDA viewed from the front, the right, and the left; and

FIG. 7 is a block diagram of the PDA.

### DETAILED DESCRIPTION

Exemplary embodiments of a handy reader of the present invention are explained in detail below with reference to the accompanying drawings.

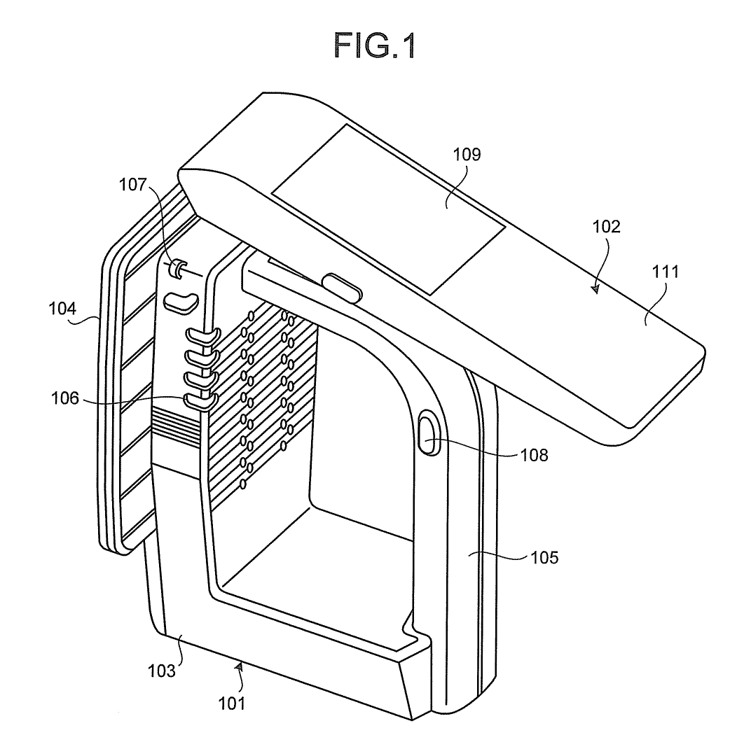

An embodiment of the present invention is explained with reference to FIGS. 1 to 7. In this embodiment, for example, a reader for an RFID tag (hereinafter referred to as RFID tag reader) mounted with a battery and usable by a user with one hand is applied as a handy reader.

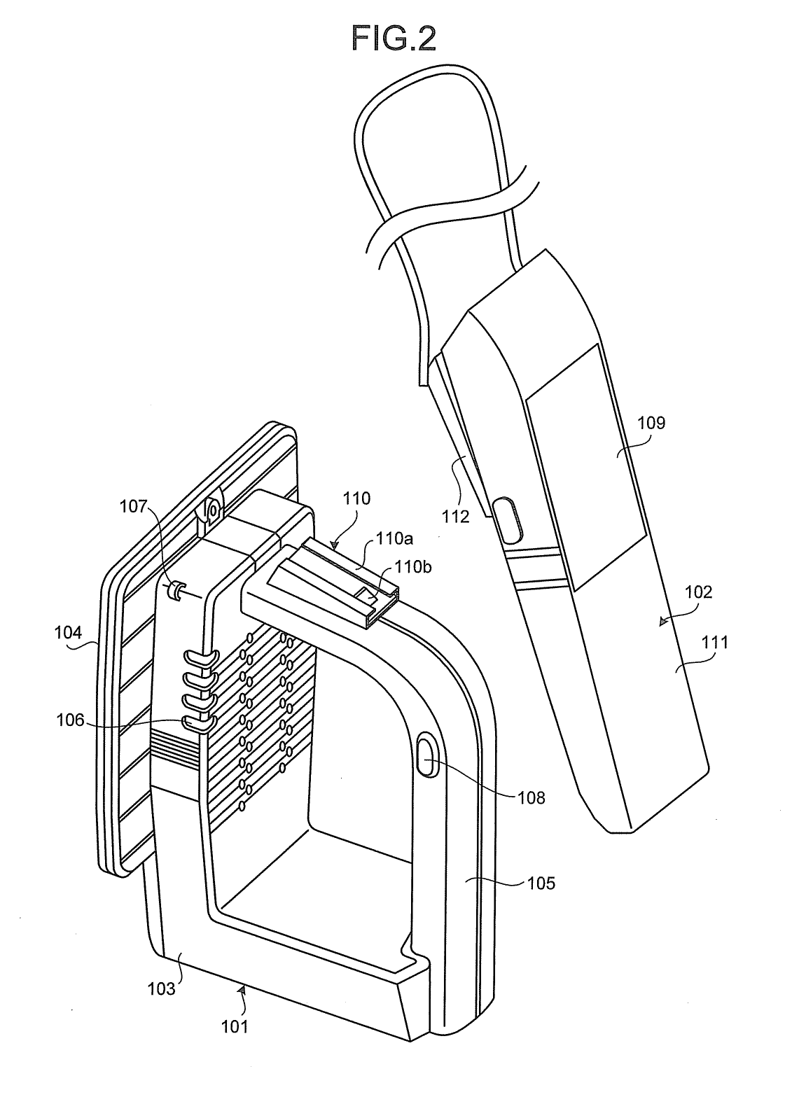

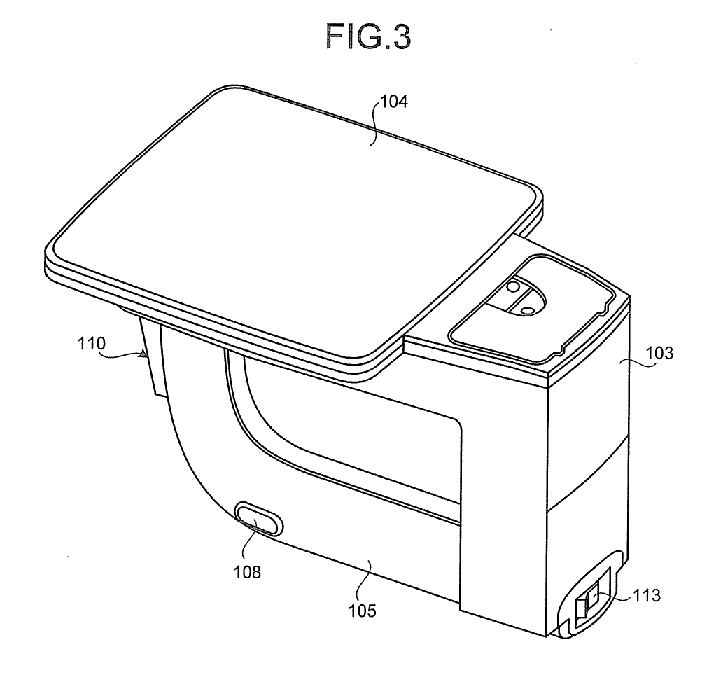

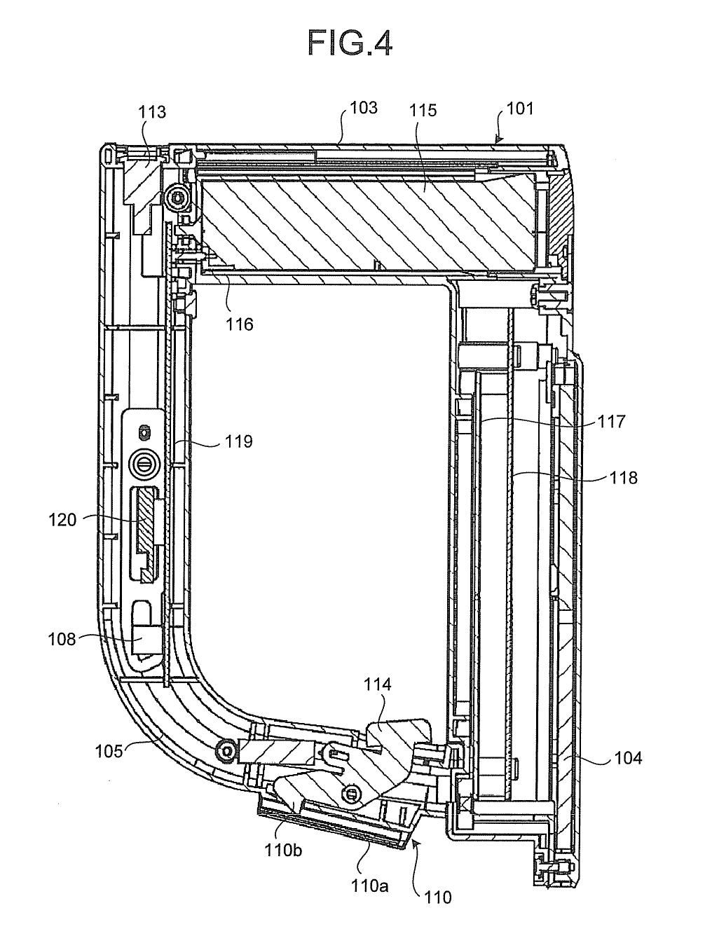

FIG. 1 is a perspective view of an external form of the RFID tag reader viewed from a side thereof. FIG. 2 is a perspective view of an external form of the RFID tag reader, from which a PDA is detached, viewed from the side. FIG. 3 is a perspective view of an external form of the RFID tag reader viewed from another side thereof. FIG. 4 is a longitudinal sectional view of the RFID tag reader. As shown in FIG. 1, an RFID tag reader 101 according to this embodiment roughly includes a main body unit 103 and an antenna unit 104.

The antenna unit 104 performs radio communication with an RFID (Radio Frequency Identification) tag (a radio tag) having data stored therein. For example, the antenna unit 104 reads the data stored in the RFID tag. The antenna unit 104 is one of heavy components among components included in the RFID tag reader 101. Therefore, in the RFID tag reader 101, the antenna unit 104 is arranged in a position opposed to a grip 105 (explained later) and the center of gravity is set near the grip 105 included in the main body unit 103.

The main body unit 103 is formed in a substantially L shape and includes the grip 105, a display unit 106, a strap attaching section 107, a start SW 108, a fixing member 110, a lever 114, a battery 115, an RF-PCB 117, a digital PCB 118, and a PCB 119.

The grip 105 is formed in a substantially L shape that couples both ends of the substantially L-shaped main body unit 103. The grip 105 is a gripping section that the user grips with one hand in using the RFID tag reader 101.

The RFID tag reader 101 is provided with the start SW (switch) 108 on a side of the grip 105. The start SW 108 switches ON and OFF of radio communication with the RFID tag by the antenna unit 104. In this embodiment, the start SW 108 is made of a material having elasticity such as nylon. As measures against creep, load is not applied to the start SW 108 except when the start SW 108 is depressed.

The fixing member 110 detachably fixes a PDA (Personal Digital Assistant) 102. The PDA 102 includes a display unit 109 configured to display data read by the antenna unit 104 and an operation unit 111 for operating the RFID tag reader 101. In this embodiment, the fixing member 110 is provided near the end on the antenna unit 104 side of the grip 105 and includes a rail 110a and a pawl section 110b.

A holder 112 provided on the rear surface (a surface on the opposite side of a surface on which the display unit 109 is provided) of the PDA 102 is fit in the rail 110a. The pawl section 110b engages with a pawl section (not shown) also provided on the rear surface of the PDA 102.

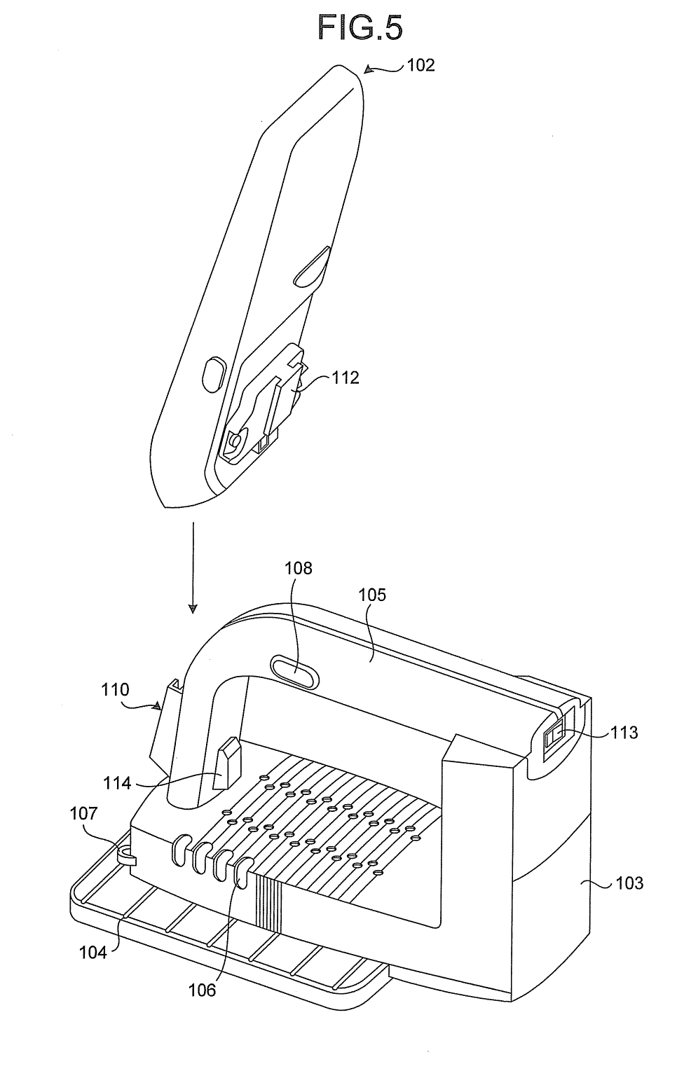

FIG. 5 is a diagram for explaining a method of fixing the PDA to the RFID tag reader. As shown in FIG. 5, the holder 112 provided on the rear surface of the PDA 102 is fit in the rail 110a and the PDA 102 is slid in a direction indicated by an arrow, whereby the pawl section (not shown) provided on the rear surface of the PDA 102 and the pawl section 110b engage to make it impossible to detach the PDA 102. Specifically, the fixing member 110 fixes the PDA 102 in a form in which the display unit 109 can be visually recognized and the operation unit 111 can be operated by a finger (e.g., thumb) of a hand that grips the grip 105. Even when the PDA 102 is fixed to the RFID tag reader 101 and reads data stored in an RFID tag with the antenna unit 104 directed to the RFID tag, the user can easily check the data displayed on the display unit 109. This makes it easy to operate the operation unit 111 included in the PDA 102.

When the user depresses the lever 114 explained later of the RFID tag reader 101, the pawl section (not shown) provided on the rear surface of the PDA 102 and the pawl section 110b are disengaged. The user can detach the PDA 102 from the main body unit 103 by sliding the PDA 102 in a direction opposite to the arrow shown in FIG. 5.

In this embodiment, the fixing member 110 includes the rail 110a and the pawl section 110b. However, any fixing member may be adopted as long as the fixing member detachably fixes the PDA 102. For example, it is also possible to use a magnet (e.g., an S pole) for the fixing member 110 and detachably fix the PDA 102 through attraction with a magnet (e.g., an N pole) provided on the rear surface of the PDA 102.

In the RFID tag reader 101, the lever 114 is provided near the end on the antenna unit 104 side of the grip 105. The lever 114 disengages the pawl section 110b and the pawl section (not shown) provided on the rear surface of the PDA 102.

The RFID tag reader 101 incorporates the PCB (Printed Circuit Board) 119 in the grip 105. The PCB 119 is a substrate mounted with a main SW 113, a Bluetooth module 120, a battery contact terminal 116, and the like.

The RFID tag reader 101 is mounted with the Bluetooth module 120 on the PCB 119. The Bluetooth module 120 performs radio communication with the PDA 102 by Bluetooth. For example, the Bluetooth module 120 is a module configured to transmit data read from the RFID tag by the antenna unit 104 to the PDA 102. In this embodiment, the Bluetooth module 120 is used as a device configured to perform the radio communication with the PDA 102. However, any device may be adopted as long as the device performs the radio communication with the PDA 102. For example, the device may be a device configured to perform the radio communication with the PDA 102 through a wireless LAN.

The RFID tag reader 101 is mounted with the main SW 113 on the PCB 119 and near the end on the opposite side of the end on the antenna unit 104 side of the grip 105. The main SW 113 switches ON and OFF of a power supply for the RFID tag reader 101. In this embodiment, a small seesaw SW is used as the main SW 113.

The battery 115 is one of heavy components among components included in the RFID tag reader 101 as in the antenna unit 104. The battery 115 supplies electric power to the entire RFID tag reader 101. Therefore, in the RFID tag reader 101, the battery 115 is arranged near the end on the opposite side of the end on the antenna unit 104 side of the grip 105.

The RFID tag reader 101 is mounted with the battery contact terminal 116 on the PCB 119. The battery contact terminal 116 transmits the electric power, which is supplied from the battery 115, to various electronic components mounted on the PCB 119.

The display unit 106 includes four LEDs (Light Emitting Diodes). The LEDs notify the user of the radio communication performed by the antenna unit 104, the radio communication performed by the Bluetooth module 120, ON and OFF of the power supply for the RFID tag reader 101 by the main SW 113, and an error that occurs in the RFID tag reader 101.

In this embodiment, chip LEDs (side emission) are used as the LEDs of the display unit 106. The RFID tag reader 101 is mounted with a LED on the digital PCB 118 that is a LED substrate mounted adjacent to the various PCBs mounted in the main body unit 103.

In the RFID tag reader 101, the digital PCB 118 is provided between the antenna unit 104 and the display unit 106. The digital PCB 118 is mounted with the LED included in the display unit 106 and an electronic component configured to control light emission of the LED.

In the RFID tag reader 101, the RF-PCB 117 is provided adjacent to the digital PCB 118. The RF-PCB 117 is mounted with an electronic component configured to control radio communication with the RFID tag by the antenna unit 104.

In the RFID tag reader 101, the strap attaching section 107 is provided on a side of the main body unit 103. A strap through which the wrist or the like of the user is inserted is attached to the strap attaching section 107.

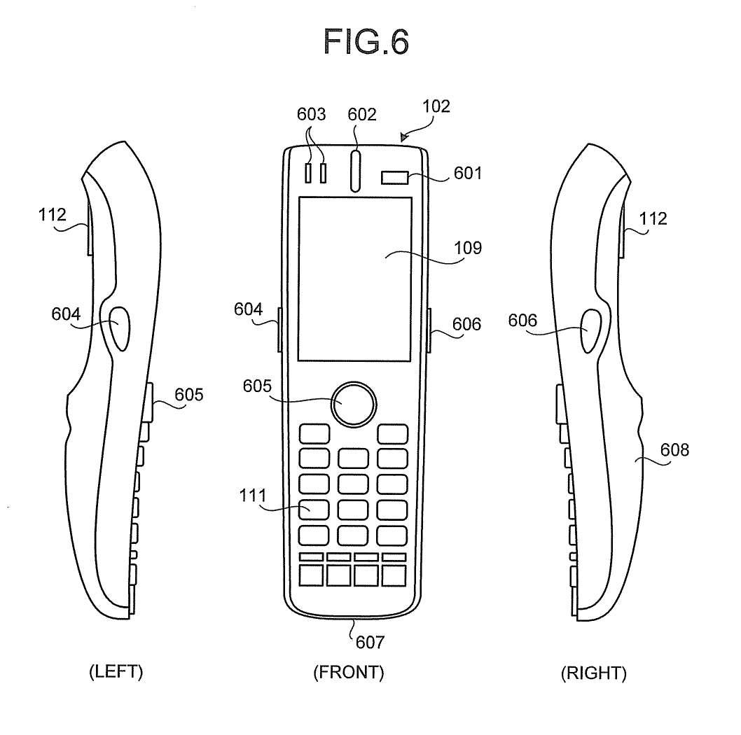

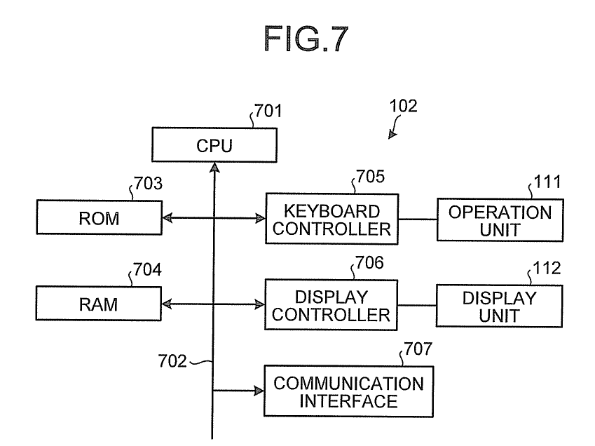

The PDA 102 detachably fixed to the RFID tag reader 101 is briefly explained with reference to FIGS. 6 and 7. FIG. 6 is a diagram of external forms of the PDA viewed from the front, the right, and the left. FIG. 7 is a block diagram of the PDA.

The PDA 102 includes, as shown in FIG. 6, the display unit 109, the operation unit 111, the holder 112, a power key 601, a barcode reading port 602, an indicator 603, an L trigger key 604, a center trigger key 605, an R trigger key 606, an I/O box terminal 607, and a rechargeable battery back cover 608.

The display unit 109 is a color liquid crystal display and displays various data such as data read by the antenna unit 104.

The operation unit 111 is a keyboard including a ten key and the like for inputting numbers 0 to 9, kana (the Japanese syllabary), and alphabets. The operation unit 111 is used for operating the RFID tag reader 101 and the PDA 102.

In the PDA 102, the holder 112 is provided on a surface on the opposite side of the surface on which the display unit 109 is provided. The holder 112 is fit in the rail 110a included in the RFID tag reader 101.

The power key 601 is a key for switching ON and OFF of a power supply for the PDA 102. The barcode reading port 602 is a section for reading a barcode attached to a commodity with a not-shown barcode reader. The indicator 603 includes a LED for checking charging and a LED for checking an operation state. The L trigger key 604, the center trigger key 605, and the R trigger key 606 are keys for instructing execution of various functions of the PDA 102. The I/O box terminal 607 is a connection terminal for connecting the PDA 102 to a charger and the like. The rechargeable battery back cover 608 is a cover for a battery (a rechargeable battery) included in the PDA 102.

The PDA 102 includes a CPU (Central Processing Unit) 701 functioning as an arithmetic device and a control device. In the PDA 102, a ROM (Read Only Memory) 703, a RAM (Random Access Memory) 704, a keyboard controller 705, a display controller 706, and a communication interface 707 are connected to the CPU 701 via a bus line 702 such as an address bus and a data bus.

The ROM 703 has stored therein a computer program that is read out by the CPU 701 and causes the CPU 701 to execute various functions and stationary data as a target of data processing by the computer program.

The RAM 704 dynamically forms various memory areas such as a work area for the data processing by the computer program.

The keyboard controller 705 processes an input signal from the operation unit 111 and sends, for example, a key code corresponding to an operated key to the bus line 702.

The display controller 706 controls the display unit 109 to display, according to a command from the CPU 701 or the like, information based on, for example, data received from the communication interface 707 via the bus line 702.

The communication interface 707 includes a radio communication device such as a wireless LAN or Bluetooth. The communication interface 707 receives data read from the RFID tag by the antenna unit 104 included in the RFID tag reader 101 and outputs the received data to the display controller 706 via the bus line 702.

A state of use of the RFID tag reader 101 according to this embodiment is explained below. For example, when the user exchanges data with an RFID tag attached to a book stored in an upper shelf of stacks in a library through radio communication, the user separates the PDA 102 from the RFID tag reader 101 and brings only the RFID tag reader 101 close to the book. Since the user has the PDA 102 at hand, the user can check, by the user's side, data displayed on the display unit 109 of the PDA 102. When the user exchanges data with an RFID tag attached to a book stored in a middle shelf or a lower shelf of the stacks through radio communication, the user reads data from the RFID tag while keeping the PDA 102 fixed to the RFID tag reader 101 by the fixing member 110. The user can easily check data displayed on the display unit 109 and can easily perform operation of the operation unit 111 included in the PDA 102.

As explained above, the RFID tag reader 101 according to this embodiment includes the antenna unit 104 configured to read data stored in an RFID tag, the fixing member 110 configured to detachably fix the PDA 102, and the Bluetooth module 120 configured to perform radio communication with the PDA 102 through the Bluetooth to thereby transmit the data read from the RFID tag by the antenna unit 104 to the PDA 102. Therefore, since the user can separate the PDA 102 from the RFID tag reader 101 and use the PDA 102, even when reading data from an RFID tag located in a position away from the user, the user can easily see, by the user's side, a result of the reading of the data from the RFID tag.

Further effects and modifications can be easily derived by those skilled in the art. Therefore, a wider aspect of the present invention is not limited by the specific details and the representative embodiment represented and described above. Therefore, various modifications are possible without departing from the spirit or the scope of the general concept of the invention defined by the appended claims and their equivalents.

What is claimed is:

1. A handy reader comprising:
antenna unit configured to perform radio communication with a radio tag having data stored therein to thereby read the data stored in the radio tag;
a fixing member configured to detachably fix a portable terminal mounted with a display unit configured to display the data read from the radio tag by the antenna unit; and
a communication unit configured to perform radio communication with the portable terminal to thereby transmit and receive the data.

2. The handy reader according to claim 1, wherein the fixing member fixes the portable terminal in a form in which the display unit mounted on the portable terminal can be visually recognized.

3. The handy reader according to claim 1, wherein the fixing member fixes the portable terminal in a form in which an operation unit mounted on the portable terminal can be operated by a finger of a hand that grips a gripping section.

4. The handy reader according to claim 1, wherein the communication unit performs the radio communication with the portable terminal through Bluetooth.

5. The handy reader according to claim 3, wherein the fixing member fixes the portable terminal in a form in which the operation unit mounted on the portable terminal can be operated by a thumb of the hand that grips the gripping section.

6. The handy reader according to claim 1, wherein the communication unit performs the radio communication with the portable terminal through a wireless LAN (Local Area Network)

7. The handy reader according to claim 1, further comprising a gripping section gripped when the handy reader is used, wherein
the antenna unit is arranged in a position opposed to the gripping section.

8. The handy reader according to claim 1, wherein the fixing member includes:
a rail in which a holder is fit, the holder being provided on a rear surface on an opposite side of a surface on which the display unit is mounted of the portable terminal; and
a pawl section configured to engage with a pawl section provided on the rear surface of the portable terminal.

9. The handy reader according to claim 1, wherein the fixing member includes a magnet configured to detachably fix the portable terminal through attraction with a magnet provided on a rear surface on an opposite side of a surface on which the display unit is mounted of the portable terminal.

10. The handy reader according to claim 1, further comprising a start switch configured to switch ON and OFF of the radio communication with the radio tag by the antenna unit and made of a material having elasticity.
